(19) United States
(12) Patent Application Publication
(10) Pub. No.: US 2025/0224646 A1
(43) Pub. Date: Jul. 10, 2025

(54) Adhesive Layer Comprising Conductive Filler Particles and a Polymeric Dispersant

(71) Applicant: E Ink Corporation, Billerica, MA (US)

(72) Inventors: Jing XIAO, Fremont, CA (US); Lei LIU, Fremont, CA (US); Mary E. PARENT, Mountain View, CA (US)

(21) Appl. No.: 19/008,580

(22) Filed: Jan. 2, 2025

Related U.S. Application Data
(60) Provisional application No. 63/618,497, filed on Jan. 8, 2024.

(51) Int. Cl. G02F 1/167; C09J 9/02; C09J 11/04; C09J 11/08; C09J 133/08; G02F 1/16757

(52) U.S. Cl. CPC G02F 1/167; C09J 9/02; C09J 11/04; C09J 11/08; C09J 133/08; G02F 1/16757

(57) ABSTRACT

An electro-optic device is disclosed comprising a first light transmissive electrode layer, an electro-optic material layer, a durable conductive adhesive layer, and a second electrode layer. The adhesive layer comprises an acrylic resin, a conductive filler, and a polymeric dispersant.

### RELATED APPLICATIONS

This application claims priority to U.S. Provisional patent application No. 63/618,497 filed on Jan. 8, 2024, which is incorporated by reference in its entirety, along with all other patents and patent applications disclosed herein.

### FIELD OF THE INVENTION

This invention relates to an electro-optic device comprising a durable conductive adhesive layer. The adhesive layer is formed by a solvent-based adhesive composition comprising an acrylic resin, conductive filler particles, and a dispersant.

### BACKGROUND OF THE INVENTION

The term “electro-optic”, as applied to a material or a display, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range.

The term “gray state” is used herein in its conventional meaning in the imaging art to refer to a state intermediate two extreme optical states of a pixel and does not necessarily imply a black-white transition between these two extreme states. For example, several of the E Ink patents and published applications referred to below describe electrophoretic displays in which the extreme states are white and deep blue, so that an intermediate “gray state” would actually be pale blue. Indeed, as already mentioned, the change in optical state may not be a color change at all. The terms “black” and “white” may be used hereinafter to refer to the two extreme optical states of a display and should be understood as normally including extreme optical states which are not strictly black and white, for example the aforementioned white and dark blue states. The term “monochrome” may be used hereinafter to denote a drive scheme which only drives pixels to their two extreme optical states with no intervening gray states.

Some electro-optic materials are solid in the sense that the materials have solid external surfaces, although the materials may, and often do, have internal liquid- or gas-filled spaces. Such displays using solid electro-optic materials may hereinafter for convenience be referred to as “solid electro-optic displays”. Thus, the term “solid electro-optic displays” includes rotating bichromal member displays, encapsulated electrophoretic displays, microcell electrophoretic displays and encapsulated liquid crystal displays.

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

One type of electro-optic display, which has been the subject of intense research and development for a number of years, is the particle-based electrophoretic display, in which a plurality of charged particles move through a fluid under the influence of an electric field. Electrophoretic displays can have attributes of good brightness and contrast, wide viewing angles, state bistability, and low power consumption when compared with liquid crystal displays. Nevertheless, problems with the long-term image quality of these displays have prevented their widespread usage. For example, particles that make up electrophoretic displays tend to settle, resulting in inadequate service-life for these displays.

As noted above, electrophoretic media require the presence of a fluid. In most prior art electrophoretic media, this fluid is a liquid, but electrophoretic media can be produced using gaseous fluids; see, for example, Kitamura, T., et al., “Electrical toner movement for electronic paper-like display”, IDW Japan, 2001, Paper HCS1-1, and Yamaguchi, Y., et al., “Toner display using insulative particles charged triboelectrically”, IDW Japan, 2001, Paper AMD4-4). See also U.S. Pat. Nos. 7,321,459 and 7,236,291. Such gas-based electrophoretic media appear to be susceptible to the same types of problems due to particle settling as liquid-based electrophoretic media, when the media are used in an orientation which permits such settling, for example in a sign where the medium is disposed in a vertical plane. Indeed, particle settling appears to be a more serious problem in gas-based electrophoretic media than in liquid-based ones, since the lower viscosity of gaseous suspending fluids as compared with liquid ones allows more rapid settling of the electrophoretic particles.

Numerous patents and applications assigned to or in the names of the Massachusetts Institute of Technology (MIT), E Ink Corporation, E Ink California, LLC. and related companies describe various technologies used in encapsulated and microcell electrophoretic and other electro-optic media. Encapsulated electrophoretic media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. In a microcell electrophoretic display, the charged particles and the fluid are not encapsulated within microcapsules but instead are retained within a plurality of cavities formed within a carrier medium, typically a polymeric film. [[Hereinafter, the term “microcavity electrophoretic display” may be used to cover both encapsulated and microcell electrophoretic displays.]] The technologies described in these patents and applications include:
(a) Electrophoretic particles, fluids and fluid additives; see for example U.S. Pat. Nos. 5,961,804; 6,017,584; 6,120,588; 6,120,839; 6,262,706; 6,262,833; 6,300,932; 6,323,989; 6,377,387; 6,515,649; 6,538,801; 6,580,545; 6,652,075; 6,693,620; 6,721,083; 6,727,881; 6,822,782; 6,831,771; 6,870,661; 6,927,892; 6,956,690; 6,958,849; 7,002,728; 7,038,655; 7,052,766; 7,110,162; 7,113,323; 7,141,688; 7,142,351; 7,170,670; 7,226,550; 7,230,750; 7,230,751; 7,236,290; 7,277,218; 7,286,279; 7,312,916; 7,382,514; 7,390,901; 7,473,782; 7,561,324; 7,583,251; 7,572,394; 7,576,904; 7,580,180; 7,679,814; 7,848,006; 7,903,319; 8,018,640; 8,115,729; 8,257,614; 8,270,064; 8,363,306; 8,390,918; 8,582,196; 8,654,436; 8,902,491; 8,961,831; 9,052,564; 9,341,915; 9,348,193; 9,361,836; 9,366,935; 9,372,380; 9,382,427; 9,423,666; 9,428,649; 9,557,623; 9,670,367; 9,671,667; 9,688,859; 9,726,957; 9,752,034; 9,765,015; 9,778,535; 9,778,537; 9,835,926; 9,953,588; 9,995,987; 10,025,157; 10,031,394; 10,040,954; 10,061,123; 10,062,337; 10,147,366; and 10,514,583; and U.S. Patent Application Publication Nos. 2003/0048522; 2003/0151029; 2003/0164480; 2004/0030125; 2004/0105036; 2005/0012980; 2009/0009852; 2011/0217639; 2012/0049125; 2013/0161565; 2013/0193385; 2013/0244149; 2013/0063333; 2014/0011913; 2014/0078576; 2014/0104674; 2014/0231728; 2015/0177590; 2015/0185509; 2015/0241754; 2015/0301425; and 2016/0170106;
(b) Capsules, binders, and encapsulation processes; see for example U.S. Pat. Nos. 5,930,026; 6,067,185; 6,130,774; 6,262,706; 6,327,072; 6,392,786; 6,459,418; 6,727,881, 6,839,158; 6,866,760; 6,922,276; 6,958,848; 6,987,603; 7,110,164; 7,148,128; 7,184,197; 7,304,634; 7,327,511, 7,339,715; 7,411,719; 7,477,444; 7,561,324; 7,910,175; 7,952,790; 8,129,655; 8,446,664; and U.S. patent applications Publication Nos. 2005/0156340; 2007/0091417; and 2009/0122389;
(c) Microcell structures, wall materials, and methods of forming microcells; see for example U.S. Pat. Nos. 6,672,921; 6,751,007; 6,753,067; 6,781,745; 6,788,452; 6,795,229; 6,806,995; 6,829,078; 6,850,355; 6,865,012; 6,870,662; 6,885,495; 6,930,818; 6,933,098; 6,947,202; 7,046,228; 7,072,095; 7,079,303; 7,141,279; 7,156,945; 7,205,355; 7,233,429; 7,261,920; 7,271,947; 7,304,780; 7,307,778; 7,327,346; 7,347,957; 7,470,386; 7,504,050; 7,580,180; 7,715,087; 7,767,126; 7,880,958; 8,002,948; 8,154,790; 8,169,690; 8,441,432; 8,891,156; 9,279,906; 9,291,872; 9,388,307; 9,436,057; 9,436,058; 9,470,917; 9,919,553; and 10,401,668; and U.S. patent applications Publication Nos. 2003/0203101; 2014/0050814; and 2016/0059442;
(d) Methods for filling and sealing microcells; see for example U.S. Pat. Nos. 6,545,797; 6,788,449; 6,831,770; 6,833,943; 6,930,818; 7,046,228; 7,052,571; 7,166,182; 7,347,957; 7,374,634; 7,385,751; 7,408,696; 7,557,981; 7,560,004; 7,564,614; 7,572,491; 7,616,374; 7,715,087; 7,715,088; 8,361,356; 8,625,188; 8,830,561; 9,346,987; and 9,759,978; and U.S. patent applications Publication Nos. 2002/0188053; 2004/0120024; 2004/0219306; and 2015/0098124;
(e) Films and sub-assemblies containing electro-optic materials; see for example U.S. Pat. Nos. 6,825,829; 6,982,178; 7,110,164; 7,158,282; 7,554,712; 7,561,324; 7,649,666; 7,728,811; 7,826,129; 7,839,564; 7,843,621; 7,843,624; 7,952,790; 8,034,209; 8,177,942; 8,390,301; 9,238,340; 9,470,950; 9,835,925; and U.S. patent applications Publication Nos. 2005/0122563; 2007/0237962; and 2011/0164301;
(f) Backplanes, adhesive layers and other auxiliary layers and methods used in displays; see for example U.S. Pat. Nos. D485,294; 5,930,026; 6,120,588; 6,124,851; 6,177,921; 6,232,950; 6,252,564; 6,312,304; 6,312,971; 6,376,828; 6,392,786; 6,413,790; 6,480,182; 6,498,114; 6,506,438; 6,518,949; 6,545,291; 6,639,578; 6,657,772; 6,664,944; 6,683,333; 6,710,540; 6,724,519; 6,816,147; 6,819,471; 6,825,068; 6,831,769; 6,842,279; 6,842,657; 6,865,010; 6,873,452; 6,909,532; 6,967,640; 7,012,600; 7,012,735; 7,030,412; 7,075,703; 7,106,296; 7,110,163; 7,116,318; 7,148,128; 7,167,155; 7,173,752; 7,176,880; 7,190,008; 7,206,119; 7,223,672; 7,230,751; 7,256,766; 7,259,744; 7,301,693; 7,304,780; 7,327,346; 7,327,511; 7,347,957; 7,365,733; 7,388,572; 7,401,758; 7,492,497; 7,535,624; 7,551,346; 7,554,712; 7,560,004; 7,583,427; 7,649,674; 7,667,886; 7,672,040; 7,688,497; 7,826,129; 7,830,592; 7,839,564; 7,880,958; 7,893,435; 7,905,977; 7,952,790; 7,986,450; 8,034,209; 8,049,947; 8,072,675; 8,120,836; 8,159,636; 8,177,942; 8,237,892; 8,362,488; 8,395,836; 8,437,069; 8,441,414; 8,456,589; 8,514,168; 8,547,628; 8,576,162; 8,610,988; 8,714,780; 8,743,077; 8,754,859; 8,797,258; 8,797,633; 8,797,636; 9,147,364; 9,025,234; 9,025,238; 9,030,374; 9,140,952; 9,201,279; 9,223,164; 9,238,340; 9,285,648; 9,454,057; 9,529,240; 9,620,066; 9,632,373; 9,666,142; 9,671,635; 9,715,155; 9,777,201; 9,897,891; 10,037,735; 10,190,743; 10,324,577; 10,365,533; 10,372,008; 10,446,585; 10,466,565; 10,495,941; 10,503,041; 10,509,294; 10,613,407; and U.S. patent applications Publication Nos. 2002/0060321; 2004/0085619; 2004/0105036; 2005/0122306; 2005/0122563; 2006/0255322; 2009/0122389; 2010/0177396; 2011/0164301; 2011/0292319; 2014/0192000; 2014/0210701; 2014/0368753; and 2016/0077375; and International Application Publication Nos. WO2000/038000; WO2000/005704; and WO1999/067678;
(g) Color formation and color adjustment; see for example U.S. Pat. Nos. 6,017,584; 6,545,797; 6,664,944; 6,788,452; 6,864,875; 6,914,714; 6,972,893; 7,038,656; 7,038,670; 7,046,228; 7,052,571; 7,075,502; 7,167,155; 7,385,751; 7,492,505; 7,667,684; 7,684,108; 7,791,789; 7,800,813; 7,821,702; 7,839,564; 7,910,175; 7,952,790; 7,956,841; 7,982,941; 8,040,594; 8,054,526; 8,098,418; 8,159,636; 8,213,076; 8,363,299; 8,422,116; 8,441,714; 8,441,716; 8,466,852; 8,503,063; 8,576,470; 8,576,475; 8,593,721; 8,605,354; 8,649,084; 8,670,174; 8,704,756; 8,717,664; 8,786,935; 8,797,634; 8,810,899; 8,830,559; 8,873,129; 8,902,153; 8,902,491; 8,917,439; 8,964,282; 9,013,783; 9,116,412; 9,146,439; 9,164,207; 9,170,467; 9,170,468; 9,182,646; 9,195,111; 9,199,441; 9,268,191; 9,285,649; 9,293,511; 9,341,916; 9,360,733; 9,361,836; 9,383,623; and 9,423,666; and U.S. patent applications Publication Nos. 2008/0043318; 2008/0048970; 2009/0225398; 2010/0156780; 2011/0043543; 2012/0326957; 2013/0242378; 2013/0278995; 2014/0055840; 2014/0078576; 2014/0340430; 2014/0340736; 2014/0362213; 2015/0103394; 2015/0118390; 2015/0124345; 2015/0198858; 2015/0234250; 2015/0268531; 2015/0301246; 2016/0011484; 2016/0026062; 2016/0048054; 2016/0116816; 2016/0116818; and 2016/0140909;
(h) Methods for driving displays; see for example U.S. Pat. Nos. 5,930,026; 6,445,489; 6,504,524; 6,512,354; 6,531,997; 6,753,999; 6,825,970; 6,900,851; 6,995,550; 7,012,600; 7,023,420; 7,034,783; 7,061,166; 7,061,662; 7,116,466; 7,119,772; 7,177,066; 7,193,625; 7,202,847; 7,242,514; 7,259,744; 7,304,787; 7,312,794; 7,327,511; 7,408,699; 7,453,445; 7,492,339; 7,528,822; 7,545,358; 7,583,251; 7,602,374; 7,612,760; 7,679,599; 7,679,813; 7,683,606; 7,688,297; 7,729,039; 7,733,311; 7,733,335; 7,787,169; 7,859,742; 7,952,557; 7,956,841; 7,982,479; 7,999,787; 8,077,141; 8,125,501; 8,139,050; 8,174,490; 8,243,013; 8,274,472; 8,289,250; 8,300,006; 8,305,341; 8,314,784; 8,373,649; 8,384,658; 8,456,414; 8,462,102; 8,514,168; 8,537,105; 8,558,783; 8,558,785; 8,558,786; 8,558,855; 8,576,164; 8,576,259; 8,593,396; 8,605,032; 8,643,595; 8,665,206; 8,681,191; 8,730,153; 8,810,525; 8,928,562; 8,928,641; 8,976,444; 9,013,394; 9,019,197; 9,019,198; 9,019,318; 9,082,352; 9,171,508; 9,218,773; 9,224,338; 9,224,342; 9,224,344; 9,230,492; 9,251,736; 9,262,973; 9,269,311; 9,299,294; 9,373,289; 9,390,066; 9,390,661; and 9,412,314; and U.S. patent applications Publication Nos. 2003/0102858; 2004/0246562; 2005/0253777; 2007/0091418; 2007/0103427; 2007/0176912; 2008/0024429; 2008/0024482; 2008/0136774; 2008/0291129; 2008/0303780; 2009/0174651; 2009/0195568; 2009/0322721; 2010/0194733; 2010/0194789; 2010/0220121; 2010/0265561; 2010/0283804; 2011/0063314; 2011/0175875; 2011/0193840; 2011/0193841; 2011/0199671; 2011/0221740; 2012/0001957; 2012/0098740; 2013/0063333; 2013/0194250; 2013/0249782; 2013/0321278; 2014/0009817; 2014/0085355; 2014/0204012; 2014/0218277; 2014/0240210; 2014/0240373; 2014/0253425; 2014/0292830; 2014/0293398; 2014/0333685; 2014/0340734; 2015/0070744; 2015/0097877; 2015/0109283; 2015/0213749; 2015/0213765; 2015/0221257; 2015/0262255; 2015/0262551; 2016/0071465; 2016/0078820; 2016/0093253; 2016/0140910; and 2016/0180777;
(i) Applications of displays; see for example U.S. Pat. Nos. 6,118,426; 6,473,072; 6,704,133; 6,710,540; 6,738,050; 6,825,829; 7,030,854; 7,119,759; 7,312,784; 7,705,824; 8,009,348; 8,011,592; 8,064,962; 8,162,212; 8,553,012; 8,973,837; 9,188,829; and 9,197,704; and U.S. patent applications Publication Nos. 2002/0090980; 2004/0119681; 2007/0285385; 2013/0176288; 2013/0221112; 2013/0233930; 2013/0235536; 2014/0049808; 2014/0062391; 2014/0206292; and 2016/0035291; and International Application Publication No. WO 00/36560; and
(j) Non-electrophoretic displays, as described in U.S. Pat. Nos. 6,241,921; 6,784,953; 6,795,138; 6,914,713; 6,950,220; 7,095,477; 7,182,830; 7,245,414; 7,420,549; 7,471,369; 7,576,904; 7,580,180; 7,850,867; 8,018,643; 8,023,071; 8,282,762; 8,319,759; and 8,994,705 and U.S. patent applications Publication Nos. 2005/0099575; 2006/0262249; 2007/0042135; 2007/0153360; 2008/0020007; 2012/0293858; and 2015/0277160; and applications of encapsulation and microcell technology other than displays; see for example U.S. Pat. No. 7,615,325; and U.S. patent application Publications Nos. 2015/0005720 and 2016/0012710.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, the aforementioned U.S. Pat. No. 6,866,760. Accordingly, for purposes of the present application, such polymer-dispersed electrophoretic media are regarded as sub-species of encapsulated electrophoretic media.

Although electrophoretic media are often opaque (since, for example, in many electrophoretic media, the particles substantially block transmission of visible light through the display) and operate in a reflective mode, many electrophoretic displays can be made to operate in a so-called “shutter mode” in which one display state is substantially opaque and one is light-transmissive. See, for example, U.S. Pat. Nos. 5,872,552; 6,130,774; 6,144,361; 6,172,798; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode. Electro-optic media operating in shutter mode may be useful in multi-layer structures for full color displays; in such structures, at least one layer adjacent the viewing surface of the display operates in shutter mode to expose or conceal a second layer more distant from the viewing surface.

An encapsulated electrophoretic display typically does not suffer from the clustering and settling failure mode of traditional electrophoretic devices and provides further advantages, such as the ability to print or coat the display on a wide variety of flexible and rigid substrates. Thus, the resulting display can be flexible. Further, because the display medium can be printed (using a variety of methods), the display itself can be made inexpensively.

An electrophoretic display normally comprises a layer of electrophoretic material and at least two other layers disposed on opposed sides of the electrophoretic material, one of these two layers being an electrode layer. In most such displays both the layers are electrode layers, and one or both of the electrode layers are patterned to define the pixels of the display. For example, one electrode layer may be patterned into elongate row electrodes and the other into elongate column electrodes running at right angles to the row electrodes, the pixels being defined by the intersections of the row and column electrodes. Alternatively, and more commonly, one electrode layer has the form of a single continuous electrode, and the other electrode layer is patterned into a matrix of pixel electrodes, each of which defines one pixel of the display. In another type of electrophoretic display, which is intended for use with a stylus, print head or similar movable electrode separate from the display, only one of the layers adjacent the electrophoretic layer comprises an electrode, the layer on the opposed side of the electrophoretic layer typically being a protective layer intended to prevent the movable electrode damaging the electrophoretic layer.

The manufacture of a three-layer electrophoretic display normally involves at least one lamination operation. For example, in several of the aforementioned MIT and E Ink patents and applications, there is described a process for manufacturing an encapsulated electrophoretic display in which an encapsulated electrophoretic medium comprising capsules in a binder is coated on to a flexible substrate comprising indium-tin-oxide (ITO) or a similar conductive coating (which acts as one electrode of the final display) on a plastic film, the capsules/binder coating being dried to form a coherent layer of the electrophoretic medium firmly adhered to the substrate. Separately, a backplane, containing an array of pixel electrodes and an appropriate arrangement of conductors to connect the pixel electrodes to drive circuitry, is prepared. To form the final display, the substrate having the capsule/binder layer thereon is laminated to the backplane using a lamination adhesive. (A very similar process can be used to prepare an electrophoretic display usable with a stylus or similar movable electrode by replacing the backplane with a simple protective layer, such as a plastic film, over which the stylus or other movable electrode can slide.) In one preferred form of such a process, the backplane is itself flexible and is prepared by printing the pixel electrodes and conductors on a plastic film or other flexible substrate. The obvious lamination technique for mass production of displays by this process is roll lamination using a lamination adhesive.

An electro-optic display normally comprises a layer of electro-optic material and at least two other layers disposed on opposed sides of the electro-optic material, one of these two layers being an electrode layer. In most such displays both the layers are electrode layers, and one or both of the electrode layers are patterned to define the pixels of the display. For example, one electrode layer may be patterned into elongate row electrodes and the other into elongate column electrodes running at right angles to the row electrodes, the pixels being defined by the intersections of the row and column electrodes. Alternatively, and more commonly, one electrode layer has the form of a single continuous electrode and the other electrode layer is patterned into a matrix of pixel electrodes, each of which defines one pixel of the display. In another type of electro-optic display, which is intended for use with a stylus, print head or similar movable electrode separate from the display, only one of the layers adjacent the electro-optic layer comprises an electrode, the layer on the opposed side of the electro-optic layer typically being a protective layer intended to prevent the movable electrode damaging the electro-optic layer.

The manufacture of a three-layer electro-optic display normally involves at least one lamination operation. For example, in several of the aforementioned MIT and E Ink patents and applications, there is described a process for manufacturing an encapsulated electrophoretic display in which an encapsulated electrophoretic medium comprising capsules in a binder is coated on to a flexible substrate comprising indium-tin-oxide (ITO) or a similar conductive coating (which acts as one electrode of the final display) on a plastic film, the capsules/binder coating being dried to form a coherent layer of the electrophoretic medium firmly adhered to the substrate.

The aforementioned U.S. Pat. No. 6,982,178 describes a method of assembling a solid electro-optic display (including an encapsulated electrophoretic display) which is well adapted for mass production. Essentially, this patent describes a so-called “front plane laminate” (“FPL”) which comprises, in order, a light-transmissive electrically-conductive layer; a layer of a solid electro-optic medium in electrical contact with the electrically-conductive layer; an adhesive layer; and a release sheet. Typically, the light-transmissive electrically-conductive layer will be carried on a light-transmissive substrate, which is preferably flexible, in the sense that the substrate can be manually wrapped around a drum (say) 10 inches (254 mm) in diameter without permanent deformation. The term “light-transmissive” is used in this patent and herein to mean that the layer thus designated transmits sufficient light to enable an observer, looking through that layer, to observe the change in display states of the electro-optic medium, which will normally be viewed through the electrically-conductive layer and adjacent substrate (if present); in cases where the electro-optic medium displays a change in reflectivity at non-visible wavelengths, the term “light-transmissive” should of course be interpreted to refer to transmission of the relevant non-visible wavelengths. The substrate will typically be a polymeric film, and will normally have a thickness in the range of about 1 to about 25 mil (25 to 634 μm), preferably about 2 to about 10 mil (51 to 254 μm). The electrically-conductive layer is conveniently a thin metal or metal oxide layer of, for example, aluminum or ITO, or may be a conductive polymer. Poly(ethylene terephthalate) (PET) films coated with aluminum or ITO are available commercially, for example as “aluminized Mylar” (“Mylar” is a Registered Trademark) from E.I. du Pont de Nemours & Company, Wilmington DE, and such commercial materials may be used with good results in the front plane laminate.

Assembly of an electro-optic display using such a front plane laminate may be effected by removing the release sheet from the front plane laminate and contacting the adhesive layer with the backplane under conditions effective to cause the adhesive layer to adhere to the backplane, thereby securing the adhesive layer, layer of electro-optic medium and electrically-conductive layer to the backplane. This process is well-adapted to mass production since the front plane laminate may be mass produced, typically using roll-to-roll coating techniques, and then cut into pieces of any size needed for use with specific backplanes.

U.S. Pat. No. 7,561,324 describes a so-called “double release sheet” which is essentially a simplified version of the front plane laminate of the aforementioned U.S. Pat. No. 6,982,178. One form of the double release sheet comprises a layer of a solid electro-optic medium sandwiched between two adhesive layers, one or both of the adhesive layers being covered by a release sheet. Another form of the double release sheet comprises a layer of a solid electro-optic medium sandwiched between two release sheets. Both forms of the double release film are intended for use in a process generally similar to the process for assembling an electro-optic display from a front plane laminate already described, but involving two separate laminations; typically, in a first lamination the double release sheet is laminated to a front electrode to form a front sub-assembly, and then in a second lamination the front sub-assembly is laminated to a backplane to form the final display, although the order of these two laminations could be reversed if desired.

U.S. Pat. No. 7,839,564 describes a so-called “inverted front plane laminate”, which is a variant of the front plane laminate described in the aforementioned U.S. Pat. No. 6,982,178. This inverted front plane laminate comprises, in order, at least one of a light-transmissive protective layer and a light-transmissive electrically-conductive layer; an adhesive layer; a layer of a solid electro-optic medium; and a release sheet. This inverted front plane laminate is used to form an electro-optic display having a layer of lamination adhesive between the electro-optic layer and the front electrode or front substrate; a second, typically thin layer of adhesive may or may not be present between the electro-optic layer and a backplane. Such electro-optic displays can combine good resolution with good low temperature performance.

The aforementioned 2007/0109219 also describes various methods designed for high volume manufacture of electro-optic displays using inverted front plane laminates; preferred forms of these methods are “multi-up” methods designed to allow lamination of components for a plurality of electro-optic displays at one time.

Electrophoretic media and displays tend to be mechanically robust, as compared with, for example, liquid crystal displays, which require transparent, typically glass, substrates on both sides of the liquid crystal medium. Several of the aforementioned E Ink patents and applications describe processes for producing electrophoretic displays in which an electrophoretic medium is coated on to a flexible plastic substrate provided with an electrically conductive layer, and the resultant electrophoretic medium/substrate sub-assembly is laminated to a backplane containing a matrix of electrodes to form the final display. Furthermore, the aforementioned U.S. Pat. No. 6,825,068 describes a backplane useful in an electrophoretic display and based upon a stainless steel foil coated with a polyimide. Such technologies can produce flexible electrophoretic displays much less susceptible to breakage than glass-based liquid crystal displays.

However, although electrophoretic displays are mechanically robust, such displays can be damaged under extreme stress, such as may occur when a portable electrophoretic display is dropped or comes into contact with a heavy object, for example in a travel bag. Typically, such failure occurs by mechanical rupture of the capsule wall, in the case of capsule-based displays, or by rupture of the continuous phase in polymer-dispersed displays. Either type of failure allows the internal phase (the electrophoretic particles and the surrounding fluid) of the electrophoretic medium to migrate within the display. Typically, a lamination adhesive layer is present adjacent the electrophoretic medium, and the fluid dissolves in this adhesive layer, leaving behind the electrophoretic particles as an optically inactive, non-switching area which causes visual defects in any image thereafter written on the display. Accordingly, there is a need to improve the mechanical robustness of electrophoretic media and displays to reduce the occurrence of such visual defects.

Electro-optic displays manufactured using the aforementioned front plane laminates or double release films normally have a layer of lamination adhesive between the electro-optic layer itself and the backplane, and the presence of this lamination adhesive layer affects the electro-optic characteristics of the displays. In particular, the electrical conductivity of the lamination adhesive layer affects both the low temperature performance and the resolution of the display. The low temperature performance of the display can (it has been found empirically) be improved by increasing the conductivity of the lamination adhesive layer, for example by doping the layer with tetrabutylammonium hexafluorophosphate or other materials as described in the aforementioned U.S. Pat. Nos. 7,012,735 and 7,173,752. However, increasing the conductivity of the lamination adhesive layer in this manner tends to increase pixel blooming (a phenomenon whereby the area of the electro-optic layer which changes optical state in response to change of voltage at a pixel electrode is larger than the pixel electrode itself), and this blooming tends to reduce the resolution of the display. Hence, this type of display apparently intrinsically requires a compromise between low temperature performance and display resolution, and in practice it is usually the low temperature performance which is sacrificed.

In the processes described above, the lamination of the substrate carrying the electro-optic layer to the backplane may advantageously be carried out by vacuum lamination. Vacuum lamination is effective in expelling air from between the two materials being laminated, thus avoiding unwanted air bubbles in the final display; such air bubbles may introduce undesirable artifacts in the images produced on the display. However, vacuum lamination of the two parts of an electro-optic display in this manner imposes stringent requirements upon the lamination adhesive used, especially in the case of a display using an encapsulated electrophoretic medium. The lamination adhesive should have sufficient adhesive strength to bind the electro-optic layer to the layer (typically an electrode layer) to which it is to be laminated, and in the case of an encapsulated electrophoretic medium, the adhesive should also have sufficient adhesive strength to mechanically hold the capsules together. If the electro-optic display is to be of a flexible type (and one of the important advantages of rotating bichromal member and encapsulated electrophoretic displays is that they can be made flexible), the adhesive should have sufficient flexibility not to introduce defects into the display when the display is flexed. The lamination adhesive should have adequate flow properties at the lamination temperature to ensure high quality lamination, and in this regard, the demands of laminating encapsulated electrophoretic and some other types of electro-optic media are unusually difficult; the lamination has be conducted at a temperature of not more than about 130° C. since the medium cannot be exposed to substantially higher temperatures without damage, but the flow of the adhesive must cope with the relatively uneven surface of the capsule-containing layer, the surface of which is rendered irregular by the underlying capsules. The lamination temperature should indeed be kept as low as possible, and room temperature lamination would be ideal, but no commercial adhesive has been found which permits such room temperature lamination. The lamination adhesive should be chemically compatible with all the other materials in the display.

As discussed in detail in the aforementioned U.S. Pat. No. 6,831,769, a lamination adhesive used in an electro-optic display should meet certain electrical criteria, and this introduces considerable problems in the selection of the lamination adhesive. Commercial manufacturers of lamination adhesives naturally devote considerable effort to ensuring that properties, such as strength of adhesion and lamination temperatures, of such adhesives are adjusted so that the adhesives perform well in their major applications, which typically involve laminating polymeric and similar films. However, in such applications, the electrical properties of the lamination adhesive are not relevant, and consequently the commercial manufacturers pay no heed to such electrical properties. Indeed, substantial variations (of up to several fold) in certain electrical properties may exist between different batches of the same commercial lamination adhesive, presumably because the manufacturer was attempting to optimize non-electrical properties of the lamination adhesive (for example, resistance to bacterial growth) and was not at all concerned about resulting changes in electrical properties.

The lamination processes used to manufacture electro-optic displays impose stringent requirements upon the mechanical and electrical properties of the lamination adhesive. A typical electro-optic display comprises an adhesive layer that is disposed between the electro-optic material layer and one or both the electrode layers. For a robust device, the adhesive layer must be durable and resistant to void formation (i.e. delamination) over time. Voids produce visible defects in the images of the display and also reduce the useful life of the device. The problem of void formation can become more severe when the device is used outdoors, where temperature and humidity conditions may become extreme. The inventors of the present invention surprisingly found that extremely durable conductive adhesive layers can be formed by compositions that comprise an acrylic resin, a conductive filler such as carbon black, and a polymeric dispersants having a molecular structure, the molecular structure of the polymeric dispersant containing a polyalkylenimine polymer backbone or a styrene-maleic anhydride copolymer backbone and two or more side chains, at least one of the two or more side chains containing a functional group selected from the group consisting of aromatic, ester, amide, amino, quaternary ammonium, hydroxy, carboxylic acid, and polyalkylene oxide.

As mentioned above, the adhesive layer is located between the electrodes of the device, wherein the electrodes apply an electric field needed to change the electrical state of the electro-optic medium. Thus, the electrical properties of the adhesive are crucial. If the resistivity of the adhesive layer is too high, a substantial voltage drop will occur within the adhesive layer, requiring an increase in voltage across the electrodes and, as a result, increased power consumption. If the resistivity of the adhesive layer that is adjacent to the pixel electrodes is too low (that is, if the conductivity too high), a cross talk between adjacent pixel electrodes occurs, reducing the resolution of the display and leading to poor image quality.

The phenomenon is called blooming, which refers to the tendency for application of a voltage to a pixel electrode to cause a change in the optical state of the electro-optic medium over an area larger than the physical size of a pixel electrode. Because the conductivity of most materials rapidly increases with increasing temperature, the blooming phenomenon becomes more pronounced at higher temperatures. Conversely, at low temperatures, the resulting reduced conductivity may reduce the speed of switching between images or increase the voltage drop and the energy consumption. The inventors of the present invention surprisingly found that the difference between the resistivity at low temperature and that at high temperature is significantly smaller for adhesive layers that comprise a crosslinked acrylic resin, a conductive filler such as carbon black, and a polymeric dispersants, compared to similar adhesive layers that comprise a non-crosslinked resin. Thus, the utilization of an inventive adhesive layer mitigates blooming at high temperatures, improving the optical performance of the inventive device without significantly affecting the switching speed and energy consumption at low temperatures.

### SUMMARY OF THE INVENTION

In one aspect, the present invention provides an electro-optic device comprising, in order, a first light transmissive electrode layer, an electro-optic material layer, an adhesive layer, and a second electrode layer. The second electrode layer comprises a plurality of pixel electrodes. The electro-optic material layer comprises a microcell layer or a microcapsule layer.

The microcell layer comprises a plurality of microcells and a sealing layer, each microcell of the plurality of microcells comprising a microcell bottom, partition walls, and an opening. The sealing layer spans the opening of each microcell. Each microcell of the plurality of microcells contains an electrophoretic medium, the electrophoretic medium comprising charged pigment particles in a non-polar liquid. The adhesive layer is disposed between the sealing layer of the microcell layer and the second electrode layer.

The microcapsule layer comprises a plurality of microcapsules and a binder. Each microcapsule of the plurality of microcapsules contains an electrophoretic medium. The electrophoretic medium comprises charged pigment particles in a non-polar liquid. The adhesive layer is disposed between the microcapsule layer and the second electrode layer.

The adhesive layer comprises an acrylic resin at a content of from 30 weight percent to 90 weight percent by weight of the adhesive layer excluding volatile solvents; a conductive filler at a content of from 5 weight percent to 35 weight percent of the conductive filler by weight of the adhesive layer excluding volatile solvents; and a polymeric dispersant at a content of from 1 weight percent to 20 weight percent by weight of the adhesive layer excluding volatile solvents.

The acrylic resin of the adhesive layer may be crosslinked. The acrylic resin may be crosslinked with a metal acetylacetonate crosslinker. The metal acetylacetonate crosslinker may be titanium acetylacetonate or aluminum acetylacetonate. The acrylic resin may be crosslinked with a melamine derivative. The melamine derivative may contain a functional group selected from the group consisting of methoxymethyl functional group and methylol functional group.

The conductive filler of the adhesive layer may be carbon black. The adhesive layer may also comprise a rheology modifier. The rheology modifier may be a cellulosic polymer.

The polymeric dispersant of the adhesive layer has a molecular structure, the molecular structure of the polymeric dispersant containing a polymer or copolymer backbone and two or more side chains. The polymer or copolymer backbone may be a styrene-maleic anhydride copolymer or a polyalkylenimine polymer. At least one of the two or more side chains may contain a functional group selected from the group consisting of aromatic, ester, amide, amino, quaternary ammonium, hydroxy, carboxylic acid, and polyalkylene oxide. The number average molecular weight of the polymeric dispersant may be from 800 to 4000 g/mol.

In one embodiment, the molecular structure of the polymeric dispersant contains a styrene-maleic anhydride copolymer backbone and at least one of the two or more side chains may contain an amino functional group or a quaternary ammonium functional group. At least one of the two or more side chains may contain a quaternary ammonium group and a polyester side chain. At least one of the two or more side chains may contain a polyethylene oxide, a polypropylene oxide, or both a polyethylene oxide and a polypropylene oxide. At least one of the two side chains may contain an aromatic ring. The polymeric dispersant may have an amine value of from 12 to 50 mg KOH/g or from 15 to 30 mg KOH/g.

In another embodiment, the molecular structure of the polymeric dispersant contains a polyalkylenimine polymer backbone and at least one of the two or more side chains contains an amino or a quaternary ammonium functional group. The polyalkylenimine polymer backbone may be a polyethylenimine polymer backbone. At least one of the two or more side chains may contain an ester functional group, and a polyethylene oxide functional group. At least one of the two or more side chains may contain a polyethylene oxide, a polypropylene oxide, or both a polyethylene oxide and a polypropylene oxide. At least one of the two side chains may contain an aromatic ring. The polymeric dispersant may have an amine value of from 15 to 60 mg KOH/g, or an amine value of from 35 to 50 mg KOH/g.

The adhesive layer may be formed by curing of the adhesive composition, the adhesive composition comprising the acrylic resin, the conductive filler, the polymeric dispersant, and a volatile solvent. The curing may be achieved by solvent evaporation.

The electrophoretic medium of the electro-optic device may contain a first type and a second type of charged pigment particles. The first type of charged pigment particles may have a first charged polarity and the second type of charged pigment particles may have a second charged polarity, the second charged polarity being the opposite to the first charged polarity.

The electrophoretic medium of the electro-optic device may contain a first, second, third, and fourth types of charged pigment particles. The first and third types of charged pigment particles may have a first charged polarity and the second and fourth type of charged pigment particles may have a second charged polarity, the second charged polarity being the opposite to the first charged polarity. The first, second, and third types of charged pigment particles may comprise an organic pigment and the fourth type of charged pigment particles may comprise an inorganic pigment. The first and second types of charged pigment particles may comprise an organic pigment and the third and fourth types of charged pigment particles may comprise an inorganic pigment.

The electrophoretic medium of the electro-optic device may contain a first, second, third, and fourth types of charged pigment particles. The first, second and third types of charged pigment particles may have a first charged polarity and the fourth type of charged pigment particles may have a second charged polarity, the second charged polarity being the opposite to the first charged polarity. The first, second, and third types of charged pigment particles may comprise an organic pigment and the fourth type of charged pigment particles may comprise an inorganic pigment. The first and second types of charged pigment particles may comprise an organic pigment and the third and fourth types of charged pigment particles may comprise an inorganic pigment.

### BRIEF DESCRIPTION OF DRAWINGS

Various aspects and embodiments of the application will be described with reference to the following figures. It should be appreciated that the figures are not necessarily drawn to scale.

FIG. 1 is a side view of a portion of an electro-optic device comprising an electrophoretic medium encapsulated in a plurality of microcells. The device comprises a first light transmissive electrode layer, a microcell layer, an adhesive layer, and a second electrode layer.

FIG. 2 is a side view of a portion of an electro-optic device comprising an electrophoretic medium encapsulated in a plurality of microcapsules. The device comprises a first light transmissive electrode layer, an electrophoretic material layer, a first adhesive layer, and a second electrode layer.

FIG. 3 is a side view of a portion of an electro-optic device comprising an electrophoretic medium encapsulated in a plurality of microcapsules. The device comprises a first light transmissive electrode layer, a second adhesive layer, an electrophoretic material layer, a first adhesive layer, and a second electrode layer.

FIG. 4 shows a method for making microcells for the invention using a roll-to-roll process.

FIGS. 5A and 5B detail the production of microcells for an electro-optic display device using photolithographic exposure through a photomask of a conductor film coated with a thermoset precursor.

FIGS. 5C and 5D detail an alternate embodiment in which microcells for an electro-optic display device are fabricated using photolithography. In FIGS. 5C and 5D a combination of top and bottom exposure is used, allowing the partition walls in one lateral direction to be cured by top photomask exposure, and the partition walls in another lateral direction to be cured by bottom exposure through the opaque base conductor film.

FIGS. 6A-6D illustrate the steps of filling and sealing an array of microcells to be used in an electro-optic display device.

FIG. 7 shows the backbone structure of a styrene-maleic anhydride copolymer.

FIG. 8 shows a reaction scheme of the reaction of a styrene maleic anhydride precursor polymer with a diamine.

FIG. 9 shows the backbone structure of a polyethylenimine polymer.

FIG. 10 is a graph of the number of defects observed for the adhesive layers for Comparative Example 1 and Examples 2 and 3 after exposed to 85° C. and 85% Relative Humidity for various numbers of days.

FIG. 11 is a graph of the number of defects observed for the adhesive layers for Comparative Example 4 and Example 5 after exposed to 85° C. and 85% Relative Humidity for various numbers of days.

FIG. 12 are photographic images of the adhesive layers for Comparative Examples 1 and 4, and Examples 2, 3 and 5 after exposed to 85° C. and 85% Relative Humidity for 5 days and 10 days.

### DETAILED DESCRIPTION OF THE INVENTION

A “quaternary ammonium functional group” is a functional group comprising a positively charged nitrogen atom, the nitrogen atom of the quaternary ammonium being directly connected with four organic substituents; that is, the nitrogen of the quaternary ammonium functional group is not directly connected to a hydrogen atom.

The term “amino functional group” may be a primary amino functional group, a secondary amino functional group, or a tertiary amino functional group.

The molecular structure of the polymeric dispersant of the inventive adhesive layer contains a polymer or copolymer backbone and two or more side chains. The polymer or copolymer backbone may be a linear polymer or a branched polymer. The side chains of the molecular structure has different functional groups from the functional groups of the backbone.

The acrylic resin of the adhesive layer of the inventive electro-optic device may be crosslinked with a melamine derivative. Nonlimiting examples of melamine derivative crosslinkers can be represented by Formula I, wherein R1 to R6 are selected from the group consisting of methylol (—CH₂OH) and methoxyalkyl (—CH₂OR) groups, wherein R is an alkyl group. Commercial crosslinkers of this type include Cymel® 303, which is a methoxymethyl-substituted melamine, and Cymel® 370, which is a methoxymethyl- and methylol-substituted melamine.

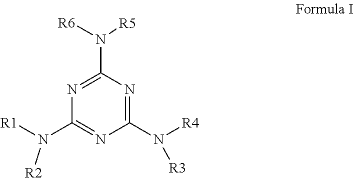

The acrylic resin of the adhesive layer of the inventive electro-optic device may be crosslinked with a metal acetylacetonate crosslinker. Nonlimiting examples of this class of crosslinkers include titanium acetylacetonate (Formula II) and aluminum acetylacetonate (Formula III).

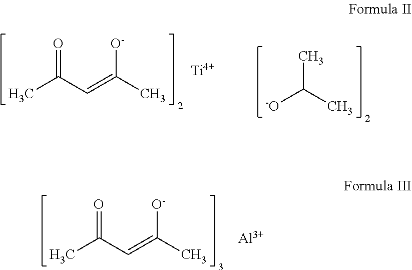

The adhesive composition, which is used to form the adhesive layer, may comprise from 0.5 weight percent to 9 weight percent of a crosslinker by weight of the adhesive composition excluding volatile solvents. The adhesive composition may comprise from 0.7 to 8 weight percent, from 0.8 to 7 weigh percent, from 0.9 to 6 weight percent, or from 1.0 to 5 weight percent of a crosslinker by weight of the adhesive composition excluding volatile solvents.

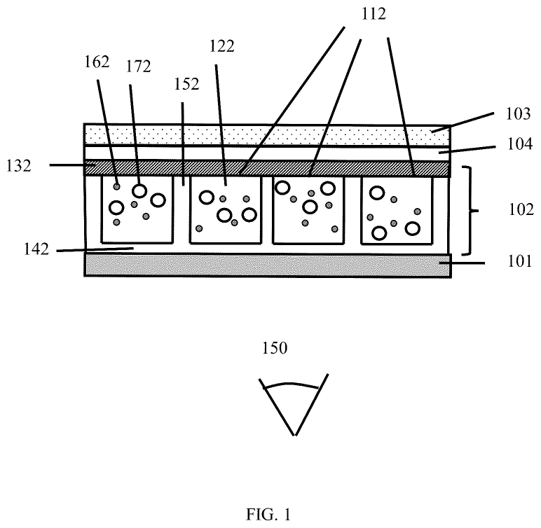

An example of an inventive electro-optic device that comprises microcells is illustrated in FIG. 1. Electro-optic device of FIG. 1 comprises, in order, a first electrode layer 101, an electro-optic material layer 102, an adhesive layer 104, and a second electrode layer 103, which comprises a plurality of pixel electrodes. Adhesive layer 104 connects sealing layer 132 of the electro-optic material layer 102 with second electrode layer 103 Electro-optic material layer 102 of electro-optic display 100 comprises a plurality of microcells 112 and a sealing layer 132. Each microcell 112 of the plurality of microcells has a bottom 142, partition walls 152, and an opening, the sealing layer 132 spanning the opening of each microcell. Each microcell 112 of the plurality of microcells comprises electrophoretic medium 122. Electrophoretic medium 122 comprises a plurality of first type of particles 172 and a plurality of second type of particles 162 in a non-polar liquid. A viewer can view the image of display 300 from the viewing side 150.

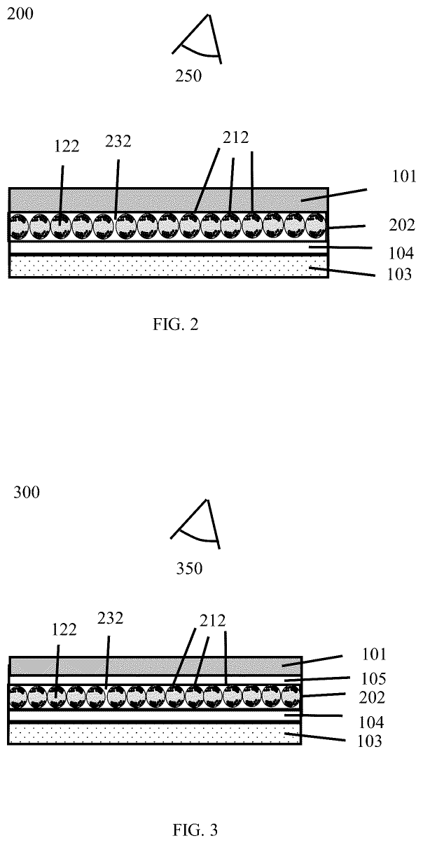

The microcell electro-optic device of FIG. 3 may further comprise a light transmissive front substrate (not shown in FIG. 1), which is adjacent to the first electrode layer 101, wherein the electrode layer is disposed between the front substrate and the electro-optic material layer. The light transmissive front substrate may be a plastic film, such as a sheet of poly(ethylene terephthalate) (PET) having thickness of from 25 to 200 μm. Light transmissive front substrate may further comprise one or more additional layers, for example, a protective layer to absorb ultraviolet radiation, barrier layers to prevent ingress of oxygen or moisture into the display, and anti-reflection coatings to improve the optical properties of the display.

Another example of an electro-optic device comprises an electro-optic material layer that includes an electrophoretic medium, which is encapsulated in microcapsules or microcells, as described in U.S. Pat. No. 6,982,178. FIG. 2 shows a side view of an example of the structure of a portion of an electro-optic display comprising microcapsules. Electro-optic display 200 comprises a first electrode layer 101 comprising a light transmissive electrode, an electro-optic material layer 202, a first adhesive layer 104, and a second electrode layer 103, the second electrode layer comprising a plurality of pixel electrodes. The first adhesive layer 104 connects the electro-optic material layer 102 with the second electrode layer. The electro-optic material layer 202 comprises a plurality of microcapsules 212. Each microcapsule has a microcapsule wall and includes electrophoretic medium 122 having particles in a non-polar liquid. Typically, the plurality of microcapsules are retained within a polymeric binder 232. A viewer can view the image of display 200 from the viewing side 250. The electro-optic material layer 100 may be constructed from a front plane laminate, as described in the background of the invention.

Another example of an electro-optic display is shown in FIG. 3. FIG. 3 illustrates a side view of an example of the basic structure of a portion of an electro-optic display having microcapsules. Electro-optic display 300 has a viewing side 350. It comprises, in order, a first electrode layer 101 comprising a light transmissive electrode, a second adhesive layer 105, an electro-optic material layer 202, a first adhesive layer 104, and a second electrode layer 103, comprising a plurality of pixel electrodes. The second adhesive layer 105 connects first electrode layer 101 with electro-optic material layer 202. The first adhesive layer 104 connects the electro-optic material layer 202 with the second electrode layer. The electro-optic material layer 202 comprises a plurality of microcapsules 212. Each microcapsule has a microcapsule wall and includes electrophoretic medium 122 having particles in a non-polar liquid. Typically, the plurality of microcapsules are retained within a polymeric binder 232. The electro-optic material layer 300 may be constructed from a double release sheet as described above.

The microcapsule electro-optic displays of FIGS. 2 and 3 may further comprise a light transmissive front substrate (not shown in FIGS. 2 and 3), which is adjacent to the first electrode layer 101, wherein the electrode layer is disposed between the front substrate and the electro-optic material layer (for the display of FIG. 2) or between the front substrate and the second adhesive layer (for the display of FIG. 3). The front substrate may be a plastic film, such as a sheet of poly(ethylene terephthalate) (PET) having thickness of from 25 to 200 μm. Front substrate may further comprise one or more additional layers, for example, a protective layer to absorb ultraviolet radiation, barrier layers to prevent ingress of oxygen or moisture into the display, and anti-reflection coatings to improve the optical properties of the display.

In the electro-optic displays of FIGS. 1, 2, and 3, the first electrode layer may be a conductive layer having a thin continuous coating of electrically conductive material with minimal intrinsic absorption of electromagnetic radiation in the visible spectral range such as indium tin oxide (ITO), poly(3,4-ethylenedioxythiophene) poly(styrene sulfonate) (PEDOT:PSS), graphene or the like.

The electrophoretic medium 122 of electro-optic devices illustrated in FIGS. 1, 2, and 3 comprises a plurality of a first type of pigment particles and a plurality of a second type of pigment particles. Each of the plurality of the first type of particles comprises a core and a shell, the core comprising an organic pigment. Each of the plurality of the second type of particles may also comprise an organic pigment. Electrophoretic medium 122 may further comprise a plurality of third type of particles and a plurality of fourth type of particles. Electrophoretic medium 122 may further comprise a plurality of fifth type of particles. That is, electrophoretic medium 122 may comprise a plurality of first, second, third, and fourth types of particles. Electrophoretic medium 122 may comprise a plurality of first, second, third, fourth type, and fifth types of particles. The second type of particles may also comprise an organic pigment. The content of the electrophoretic particles in the non-polar liquid may vary. For example, one type of particles may take up 0.1% to 50%, preferably 0.5% to 15%, by volume of the non-polar liquid.

The electrophoretic medium of the present invention may comprise a charge control agent (CCA). The CCA controls the charge on the electrophoretic particles. The CCA is a surfactant-like molecule having an ionic or other polar group, hereinafter referred to as head groups, and a non-polar chain (typically a hydrocarbon chain) that is hereinafter referred to as the tail. The CCAs may be complexed with the charged particles or adsorbed onto the particles. It is thought that the CCA forms reverse micelles in the electrophoretic medium. It is a small population of charged reverse micelles that leads to electrical conductivity in the medium. Reverse micelles comprise a polar core that may vary in size from 1 nm to tens of nanometers, and may have spherical, cylindrical, or other geometry, surrounded by the non-polar tail groups of the CCA molecule. In electrophoretic media, three phases may typically be distinguished: a solid particle having a surface, a highly polar phase that is distributed in the form of extremely small droplets (reverse micelles), and a continuous phase that comprises the non-polar fluid. Both the electrophoretic particles and the charged reverse micelles may move through the fluid upon application of an electric field. Thus, there are two parallel pathways for electrical conduction through the fluid (which typically has a vanishingly small electrical conductivity itself). The content of the charge control agent in the electrophoretic medium may be from 0.1 weight percent to 8 weight percent, from 0.3 weight percent to 7 weight percent, from 0.5 weight percent to 5 weight percent, from 0.6 weight percent to 4 weight percent, from 0.7 weight percent to 3 weight percent, or from 0.8 weight percent to 2 weight percent of the charge control agent by weight of the electrophoretic medium.

The electrophoretic medium of the present invention comprises particles suspended in a non-polar liquid. The non-polar liquid may be clear and colorless. It preferably has a dielectric constant in the range of about 2 to about 30, preferably about 2 to about 15 for high particle mobility. Examples of suitable dielectric solvent include hydrocarbons such as isopar, decahydronaphthalene (DECALIN), 5-ethylidene-2-norbornene, fatty oils, paraffin oil, silicon fluids, aromatic hydrocarbons such as toluene, xylene, phenylxylylethane, dodecylbenzene or alkylnaphthalene, halogenated solvents such as perfluorodecalin, perfluorotoluene, perfluoroxylene, dichlorobenzotrifluoride, 3,4,5-trichlorobenzoic fluoride, chloropentafluoro-benzene, dichlorononane or pentachlorobenzene, and perfluorinated solvents such as FC-43, FC-70 or FC-5060 from 3M Company, St. Paul MN, low molecular weight halogen containing polymers such as poly(perfluoropropylene oxide) from TCI America, Portland, Oregon, poly(chlorotrifluoro-ethylene) such as Halocarbon Oils from Halocarbon Product Corp., River Edge, NJ, perfluoropolyalkylether such as Galden from Ausimont or Krytox Oils and Greases K-Fluid Series from DuPont, Delaware, polydimethylsiloxane based silicone oil from Dow-corning (DC-200).

Microcells may be formed either in a batchwise process or in a continuous roll-to-roll process as disclosed in U.S. Pat. No. 6,933,098. The latter offers a continuous, low cost, high throughput manufacturing technology for production of compartments for use in a variety of applications including electro-optic display devices. Microcell arrays suitable for use with the invention can be created with microembossing, as illustrated in FIG. 4. A male mold 402 may be placed either above the web 404, as shown in FIG. 4, or below the web 404 (not shown); however, alternative arrangements are possible. See U.S. Pat. No. 7,715,088, which is incorporated herein by reference in its entirety. A conductive substrate may be constructed by forming a conductor film 401 (first electrode) on polymer substrate that becomes the backing for a device. A composition comprising a thermoplastic, thermoset, or a precursor thereof 400 is then coated on the conductor film. The thermoplastic or thermoset precursor layer is embossed at a temperature higher than the glass transition temperature of the thermoplastics or thermoset precursor layer by the male mold in the form of a roller, plate, or belt.

The thermoplastic or thermoset precursor for the preparation of the microcells may be multifunctional acrylate or methacrylate, vinyl ether, epoxide and oligomers or polymers thereof, and the like. A combination of multifunctional epoxide and multifunctional acrylate is also very useful to achieve desirable physico-mechanical properties. A crosslinkable oligomer imparting flexibility, such as urethane acrylate or polyester acrylate, may be added to improve the flexure resistance of the embossed microcells. The composition may contain polymer, oligomer, monomer and additives or only oligomer, monomer and additives. The glass transition temperatures (or T_{g}) for this class of materials usually range from about −70° C. to about 150° C., preferably from about −20° C. to about 50° C. The microembossing process is typically carried out at a temperature higher than the T_{g}. A heated male mold or a heated housing substrate against which the mold presses may be used to control the microembossing temperature and pressure.

As shown in FIG. 4, the mold is released during or after the precursor layer is hardened to reveal an array of microcells 403. The hardening of the precursor layer may be accomplished by cooling, solvent evaporation, cross-linking by radiation, heat or moisture. If the curing of the thermoset precursor is accomplished by UV radiation, UV may radiate onto the transparent conductor film from the bottom or the top of the web. Alternatively, UV lamps may be placed inside the mold. In this case, the mold must be transparent to allow the UV light to radiate through the pre-patterned male mold on to the thermoset precursor layer. A male mold may be prepared by any appropriate method, such as a diamond turn process or a photoresist process followed by either etching or electroplating. A master template for the male mold may be manufactured by any appropriate method, such as electroplating. With electroplating, a glass base is sputtered with a thin layer (typically 3000 Å) of a seed metal such as chrome inconel. The mold is then coated with a layer of photoresist and exposed to UV. A mask is placed between the UV and the layer of photoresist. The exposed areas of the photoresist become hardened. The unexposed areas are then removed by washing them with an appropriate solvent. The remaining hardened photoresist is dried and sputtered again with a thin layer of seed metal. The master is then ready for electroforming. A typical material used for electroforming is nickel cobalt. Alternatively, the master can be made of nickel by electroforming or electroless nickel deposition. The floor of the mold is typically between about 50 to 400 microns. The master can also be made using other microengineering techniques including e-beam writing, dry etching, chemical etching, laser writing or laser interference as described in “Replication techniques for micro-optics”, SPIE Proc. Vol. 3099, pp. 76-82(1997). Alternatively, the mold can be made by photomachining using plastics, ceramics or metals.

Prior to applying a UV curable resin composition, the mold may be treated with a mold release to aid in the demolding process. The UV curable resin may be degassed prior to dispensing and may optionally contain a solvent. The solvent, if present, readily evaporates. The UV curable resin is dispensed by any appropriate means such as, coating, dipping, pouring or the like, over the male mold. The dispenser may be moving or stationary. A conductor film is overlaid the UV curable resin. Pressure may be applied, if necessary, to ensure proper bonding between the resin and the plastic and to control the thickness of the floor of the microcells. The pressure may be applied using a laminating roller, vacuum molding, press device or any other like means. If the male mold is metallic and opaque, the plastic substrate is typically transparent to the actinic radiation used to cure the resin. Conversely, the male mold can be transparent, and the plastic substrate can be opaque to the actinic radiation. To obtain good transfer of the molded features onto the transfer sheet, the conductor film needs to have good adhesion to the UV curable resin that should have a good release property against the mold surface.

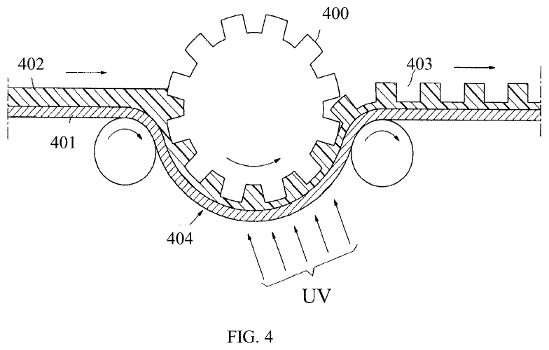

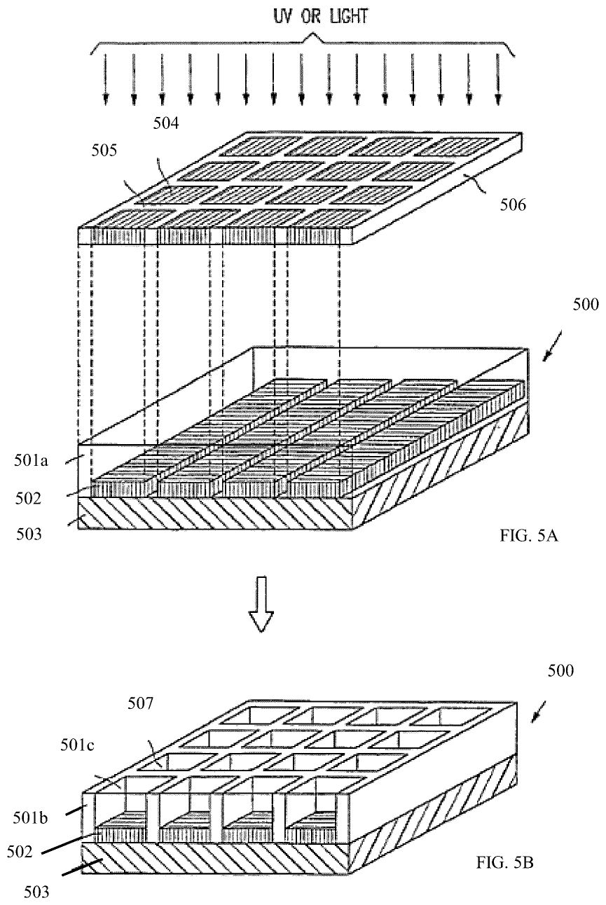

Photolithography. Microcells can also be produced using photolithography. Photolithographic processes for fabricating a microcell array are illustrated in FIGS. 5A and 5B. As shown in FIGS. 5A and 5B, the microcell array 500 may be prepared by exposure of a radiation curable material 501a coated by known methods onto a conductor film 502 to UV light (or alternatively other forms of radiation, electron beams and the like) through a mask 506 to form partition walls 501b corresponding to the image projected through the mask 506. The base conductor film 502 is preferably mounted on a supportive substrate base web 503, which may comprise a plastic material.

In the photomask 506 in FIG. 5A, the dark squares 504 represent the opaque area and the space between the dark squares represents the transparent area 505 of the mask 506. The UV radiates through the transparent area 505 onto the radiation curable material 502a. The exposure is preferably performed directly onto the radiation curable material 502a, i.e., the UV does not pass through the substrate 503 or base conductor 502 (top exposure). For this reason, neither the substrate 503, nor the conductor 502, needs to be transparent to the UV or other radiation wavelengths employed.

As shown in FIG. 5B, the exposed areas 501b become hardened and the unexposed areas (protected by the opaque area 504 of the mask 506) are then removed by an appropriate solvent or developer to form the microcells 507. The solvent or developer is selected from those commonly used for dissolving or reducing the viscosity of radiation curable materials such as methyl ethyl ketone (MEK), toluene, acetone, isopropanol or the like. The preparation of the microcells may be similarly accomplished by placing a photomask underneath the conductor film/substrate support web and in this case the UV light radiates through the photomask from the bottom and the substrate needs to be transparent to radiation.

Imagewise Exposure. Still another alternative method for the preparation of the microcell array of the invention by imagewise exposure is illustrated in FIGS. 5C and 5D. When opaque conductor lines are used, the conductor lines can be used as the photomask for the exposure from the bottom. Durable microcell partition walls are formed by additional exposure from the top through a second photomask having opaque lines perpendicular to the conductor lines. FIG. 5C illustrates the use of both the top and bottom exposure principles to produce the microcell array 510 of the invention. The base conductor film 512 is opaque and line-patterned. The radiation curable material 511a, which is coated on the base conductor 512 and substrate 513, is exposed from the bottom through the conductor line pattern 512, which serves as the first photomask. A second exposure is performed from the “top” side through the second photomask 516 having a line pattern perpendicular to the conductor lines 512. The spaces 515 between the lines 514 are substantially transparent to the UV light. In this process, the partition wall material 511b is cured from the bottom up in one lateral orientation, and cured from the top down in the perpendicular direction, joining to form an integral microcell 517. As shown in FIG. 5D, the unexposed area is then removed by a solvent or developer as described above to reveal the microcells 517.

The microcells may be constructed from thermoplastic elastomers, which have good compatibility with the microcells and do not interact with the electrophoretic media. Examples of useful thermoplastic elastomers include ABA, and (AB)n type of di-block, tri-block, and multi-block copolymers wherein A is styrene, α-methylstyrene, ethylene, propylene or norbornene; B is butadiene, isoprene, ethylene, propylene, butylene, dimethylsiloxane or propylene sulfide; and A and B cannot be the same in the formula. The number, n, is ≥1, preferably 1-10. Particularly useful are di-block or tri-block copolymers of styrene or ox-methylstyrene such as SB (poly(styrene-b-butadiene)), SBS (poly(styrene-b-butadiene-b-styrene)), SIS (poly(styrene-b-isoprene-b-styrene)), SEBS (poly(styrene-b-ethylene/butylenes-b-styrene)) poly(styrene-b-dimethylsiloxane-b-styrene), poly((α-methylstyrene-b-isoprene), poly(α-methylstyrene-b-isoprene-b-α-methylstyrene), poly(α-methylstyrene-b-propylene sulfide-b-α-methylstyrene), poly(α-methylstyrene-b-dimethyldioxane-b-α-methylstyrene). Commercially available styrene block copolymers such as Kraton D and G series (from Kraton Polymer, Houston, Tex.) are particularly useful. Crystalline rubbers such as poly(ethylene-co-propylene-co-5-methylene-2-norbornene) or EPDM (ethylene-propylene-diene terpolymer) rubbers such as Vistalon 6505 (from Exxon Mobil, Houston, Tex.) and their grafted copolymers have also been found very useful.

The thermoplastic elastomers may be dissolved in a solvent or solvent mixture that is immiscible with the display fluid in the microcells and exhibits a specific gravity less than that of the display fluid. Low surface tension solvents are preferred for the overcoating composition because of their better wetting properties over the microcell partition walls and the electrophoretic fluid. Solvents or solvent mixtures having a surface tension lower than 35 dyne/cm are preferred. A surface tension of lower than 30 dyne/cm is more preferred. Suitable solvents include alkanes (preferably C₆₋₁₂ alkanes such as heptane, octane or Isopar solvents from Exxon Chemical Company, nonane, decane and their isomers), cycloalkanes (preferably C₆₋₁₂ cycloalkanes such as cyclohexane and decalin and the like), alkylbenzenes (preferably mono- or di-C₁₋₆ alkyl benzenes such as toluene, xylene and the like), alkyl esters (preferably C₂₋₅ alkyl esters such as ethyl acetate, isobutyl acetate and the like) and C₃₋₅ alkyl alcohols (such as isopropanol and the like and their isomers). Mixtures of alkylbenzene and alkane are particularly useful.

In addition to polymer additives, the polymer mixtures may also include wetting agents (surfactants). Wetting agents (such as the FC surfactants from 3M Company, Zonyl fluorosurfactants from DuPont, fluoroacrylates, fluoromethacrylates, fluoro-substituted long chain alcohols, perfluoro-substituted long chain carboxylic acids and their derivatives, and Silwet silicone surfactants from OSi, Greenwich, Conn.) may also be included in the composition to improve the adhesion of the sealant to the microcells and provide a more flexible coating process. Other ingredients including crosslinkers (e.g., bisazides such as 4,4′-diazidodiphenylmethane and 2,6-di-(4′-azidobenzal)-4-methylcyclohexanone), vulcanizers (e.g., 2-benzothiazolyl disulfide and tetramethylthiuram disulfide), multifunctional monomers or oligomers (e.g., hexanediol, diacrylates, trimethylolpropane, triacrylate, divinylbenzene, diallylphthalene), thermal initiators (e.g., dilauroyl peroxide, benzoyl peroxide) and photoinitiators (e.g., isopropyl thioxanthone (ITX), Irgacure 651 and Irgacure 369 from Ciba-Geigy) are also highly useful to enhance the physico-mechanical properties of the sealing layer by crosslinking or polymerization reactions during or after the overcoating process.

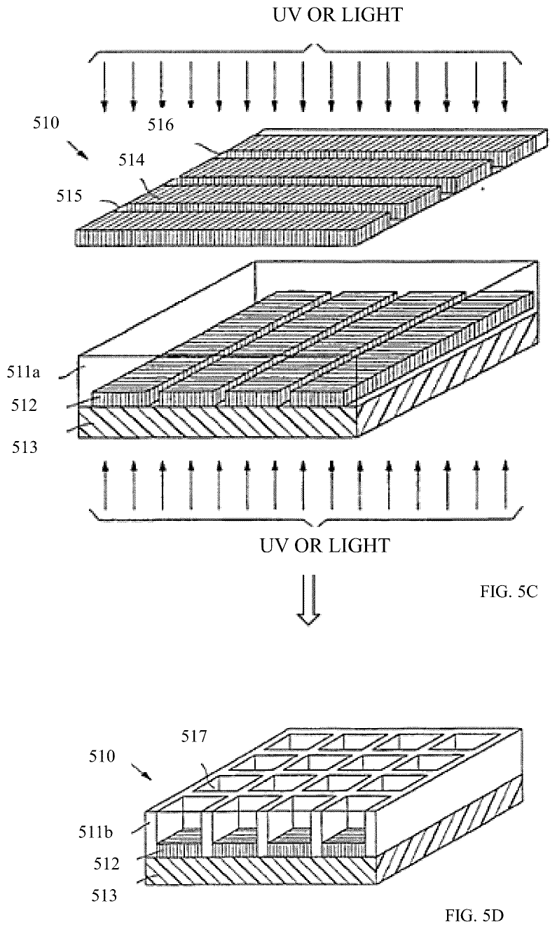

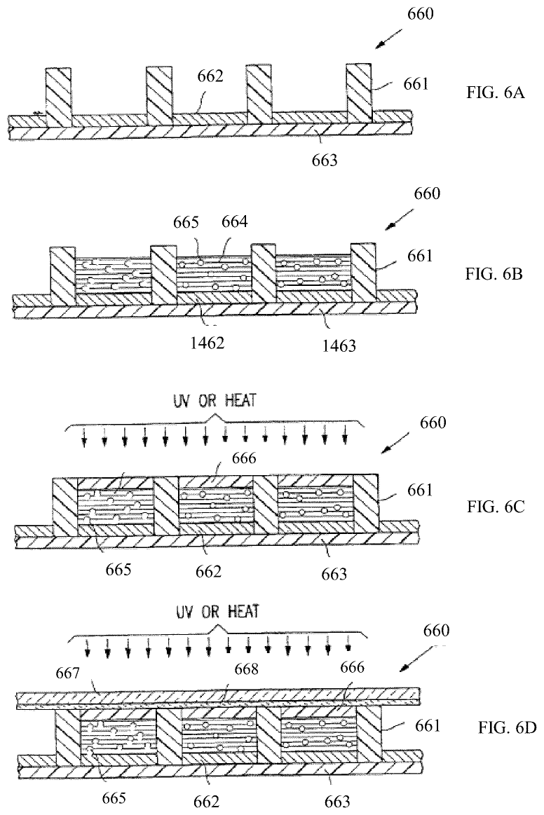

After the microcells are produced, they are filled with appropriate electrophoretic media. The microcell array 640 may be prepared by any of the methods described above. As shown in cross-section in FIGS. 6A-6D, the microcell partition walls 661 extend upward from the substrate 663 to form the open cells. The microcells may include a primer layer 662 to passivate the mixture and keep the microcell material from interacting with the mixture containing the electrophoretic medium 665.

The microcells are next filled with an electrophoretic medium 664 comprising particles 665 in a non-polar fluid. The microcells may be filled using a variety of techniques. In some examples, blade coating may be used to fill the microcells to the depth of the microcell partition walls 661. In other examples, inkjet-type microinjection can be used to fill the microcells. In yet other examples, microneedle arrays may be used to fill an array of microcells.

As shown in FIG. 6C, after filling, the microcells are sealed by applying a polymer 1466 that becomes the sealing layer. In some examples, the sealing process may involve exposure to heat, dry hot air, or UV radiation. Polymer 666 is compatible with the electrophoretic medium, but not dissolved by the fluid of the electrophoretic medium 664. Accordingly, the final microcell structure is mostly impervious to leaks and able to withstand flexing without delamination.

A variety of individual microcells may be filled with the desired electrophoretic medium by using iterative photolithography. The process typically includes coating an array of empty microcells with a layer of positively working photoresist, selectively opening a certain number of the microcells by imagewise exposing the positive photoresist, followed by developing the photoresist, filling the opened microcells with the desired mixture, and sealing the filled microcells by a sealing process.

After the microcells 660 are filled, the sealed array may be laminated with a finishing layer 668, preferably by pre-coating the finishing layer 668 with an adhesive layer that may be a pressure sensitive adhesive, a hot melt adhesive, or a heat, moisture, or radiation curable adhesive. The laminate adhesive may be post-cured by radiation such as UV through the top conductor film if the latter is transparent to the radiation.

The electro-optic device of the present invention comprises in order, a first light transmissive electrode layer, an electro-optic material layer, an adhesive layer, and a second electrode layer. The second electrode layer comprises a plurality of pixel electrodes. The electro-optic material layer comprises a microcell layer or a microcapsule layer. The adhesive layer comprises an acrylic resin at a content of from 30 weight percent to 90 weight percent by weight of the adhesive layer excluding volatile solvents; a conductive filler at a content of from 5 weight percent to 35 weight percent of the conductive filler by weight of the adhesive layer excluding volatile solvents; and a polymeric dispersant at a content of from 1 weight percent to 20 weight percent by weight of the adhesive layer excluding volatile solvents.

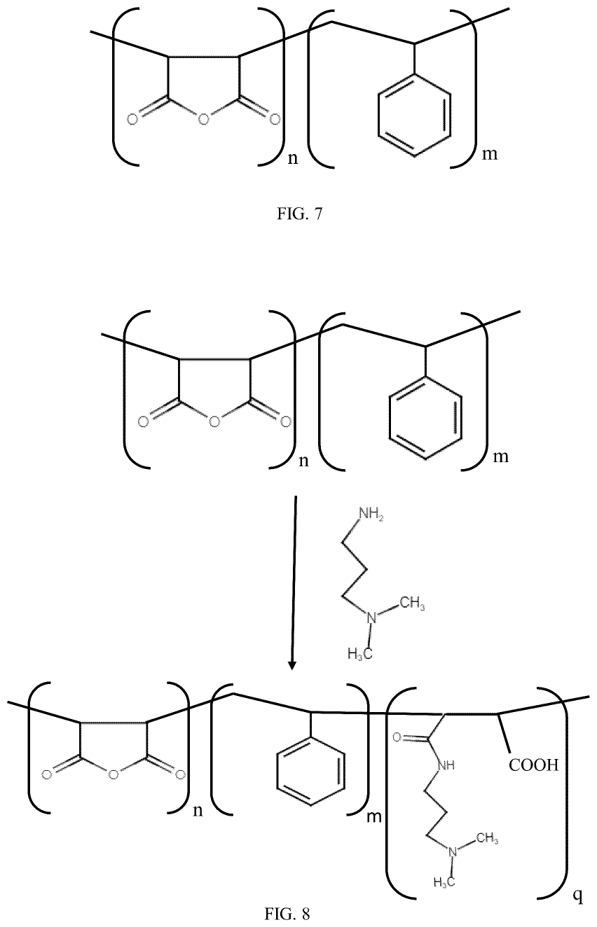

In a first embodiment, the electro-optic device of the present invention comprises an adhesive layer that comprises a polymeric dispersant having a molecular structure, the molecular structure containing a styrene-maleic anhydride copolymer backbone and two or more side chains. At least one of the two or more side chains contains an amino functional group or a quaternary ammonium functional group. The polymeric dispersant may be formed from a precursor polymer after one or more reaction steps. The precursor polymer of the first embodiment is styrene maleic anhydride copolymer. An example of this copolymer is shown in FIG. 7. This precursor styrene maleic anhydride copolymer provides the polymer backbone of the polymeric dispersant. The precursor copolymer comprises reactive anhydride functional groups, which can react with one or more reagents in one or more steps to form the polymeric dispersant. Specifically, the styrene maleic anhydride copolymer can react with a nucleophilic reagent. The reaction results in the opening of an anhydride carbonyl groups, forming side chains on the styrene maleic anhydride backbone. A nucleophilic reagent may contain, for example, an amine functional group, a hydroxy functional group, or a thiol functional group. Because the precursor styrene maleic anhydride copolymer can be designed to be a random or a block copolymer, the resulting polymeric dispersant may also have a backbone that is a random polymer or a block copolymer.

A side chain of the molecular structure of the polymeric dispersant of the first embodiment may contain a polyester. A side chain of the molecular structure of the polymeric dispersant of the first embodiment may contain a polyethylene oxide, a polypropylene oxide, or both a polyethylene oxide functional group and a polypropylene oxide. A side chain of the molecular structure of the polymeric dispersant of the first embodiment may contain an aromatic ring. This aromatic group of the side chain is separate from the aromatic rings of the styrene of the polymer backbone. The polymeric dispersant may have an amine value of from 12 to 50 mg KOH/g, from 15 to 30 mg KOH/g, or from 18 to 25 mg KOH/g. The number average molecular weight of the polymeric dispersant may be from 500 to 10,000 g/mol, from 600 to 6,000 g/mol, from 800 to 4,000 g/mol, or from 1,000 to 3,000 g/mol.

One class of reagents that can be used to form a side chain of the polymeric dispersant is diamine. For example, 3-dimethylaminopropylamine ((CH₃)₂—N—(CH₂)₃—NH₂) is a diamine that contains a primary amino functional group and a tertiary amino functional group. The primary amine can react with a carbonyl group of an anhydride group of the styrene anhydride polymer, opening the anhydride ring and forming an SMA copolymer with a side chain. Reaction of additional equivalents of the diamine with the SMA precursor polymer precursor forms a polymer according to the reaction scheme of FIG. 12, wherein q is 2 or higher. Although the product of the reaction of the scheme of FIG. 8 implies that the polymer of the product is a block copolymer, or more accurately, a block terpolymer, the polymer product may be a random terpolymer. The molecular structure of the polymeric dispersant of the first embodiment may contain two, three, four or more different side chains. It is possible that all of the maleic anhydride units of the precursor polymer are reacted with a diamine reagent to give the open ring structure. Other reagents that can be used to react with the precursor polymer include, a hydroxy amine, such as, for example 3-dimethylamino-1-propanol ((CH₃)₂—N—(CH₂)₃—OH). In this case, the hydroxy group of the reagent is attached to one of the carbonyl groups of the anhydride (similarly to the primary amine of the reaction that is shown in FIG. 8. The product of the reaction of the diamine or the hydroxy amine and the polymer SMA precursor polymer, may react with an alkylating agent, in a subsequent step, to give a quaternary ammonium functional group having a positive charge. Depending on the number of mole equivalents of the alkylating agent in relation to the tertiary amino groups, one, two, or more of the tertiary amino groups can be converted to quaternary ammonium groups.

Another class of reagents that can be used to form a polymeric dispersant from the SMA is a hydroxy carboxylic acid. The hydroxy carboxylic acid can form a polyester polymer via condensation polymerization. The anhydride of the SMA precursor polymer participates in the condensation polymerization, leading to a block copolymer having a SMA backbone and one, two or more polyester side chains. The reaction mixture may also contain other reagents such as diols or polyols. For example, the reaction mixture may contain ethylene oxide, propylene oxide, a polyethylene oxide, and/or a polypropylene oxide, introducing additional functional groups in the side chain. As mentioned above, multiple reaction steps can be used to form a variety of side chains in the same polymeric dispersant.

Other reagents can be used to form a polymeric dispersant from the SMA. For example, instead of hydroxy carboxylic acids, described in the previous paragraph, dicarboxylic acids (or dicarboxylic acid derivatives) in combination with diols can be used. This combination also forms a polyester polymer via condensation polymerization. The anhydride of the SMA precursor polymer participates in the condensation polymerization, leading to a block copolymer having a SMA backbone and one, two or more polyester side chains. The diol reagent may be ethylene oxide (—(CH₂CH₂—O)—), propylene oxide (—(CH—(CH₃)—CH₂—O)—), a polyethylene oxide (—(CH₂CH₂—O)ᵣ—), and/or a polypropylene oxide (—(CH—(CH₃)—CH₂—O)ₜ—), where r and t are integers, introducing ethylene oxide, propylene oxide, polyethylene oxide and/or polypropylene oxide in the side chain. Multiple reaction steps can be used to form a variety of side chains in the same polymeric dispersant. An aromatic reagent, such as, for example, an aniline, a benzyl amine, or a benzyl alcohol may be a reagent in the reaction described above, in order to introduce an aromatic ring in a side chain of the polymeric dispersant. An aromatic ring may be beneficial in the case where the conductive filler is a carbon black, because such aromatic rings are carbon black affinity groups (forming non-covalent interactions with carbon black particles), increasing the storage stability of the adhesive composition that is used to form the adhesive layer.

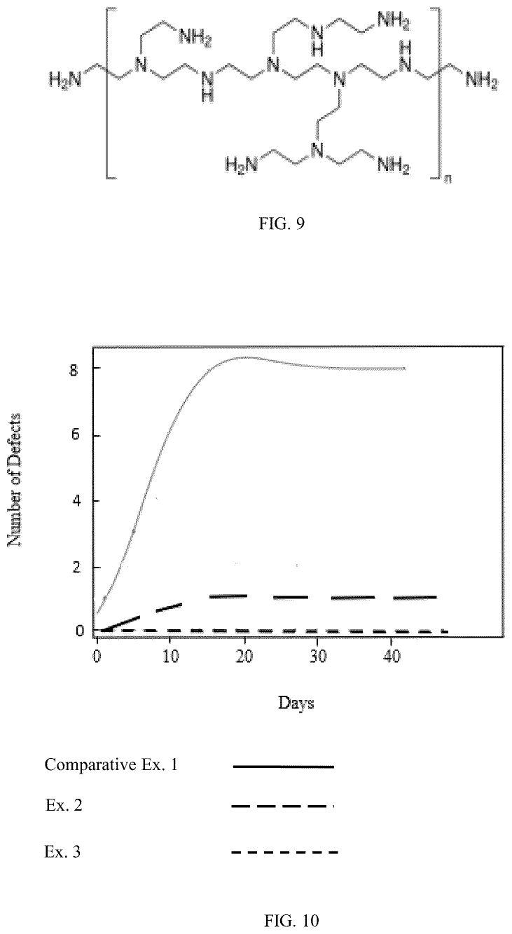

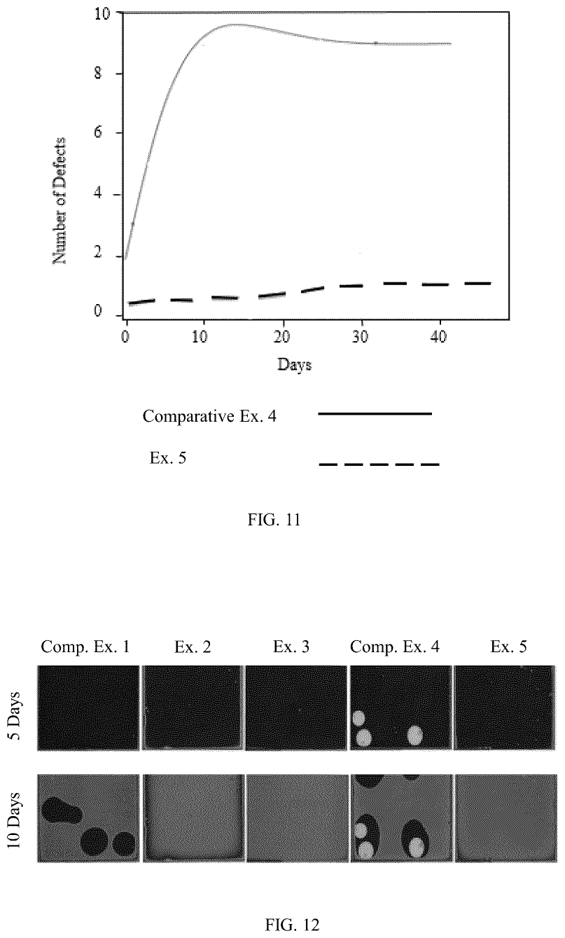

In a second embodiment, the electro-optic device of the present invention comprises an adhesive layer that comprises a polymeric dispersant having a molecular structure, the molecular structure containing polyalkylenimine polymer backbone and two or more side chains. At least one of the two or more side chains may contain a functional group selected from the group consisting of aromatic, ester, amide, amino, quaternary ammonium, hydroxy, carboxylic acid, and polyalkylene oxide. The precursor polymer may be a polyethylenimine containing primary, secondary, and tertiary functional groups. An example of such a precursor polymer is provided in FIG. 9.

A variety of reagents can be used to react with the primary, secondary, and tertiary functional groups of the precursor polymer. These reagents must contain functional groups that react with amines, such as carboxylic acids, carboxylic acid anhydrides, carboxylic acid halides, etc. Multiple reaction steps may be used to introduce different side chains in the molecular structure of the polymeric dispersant, as was explained in the examples of the first embodiments. For example, a benzyl chloride may be used to introduce a side chain having an aromatic ring. The polymeric dispersant of the second embodiment may have an amine value of from 15 to 60 mg KOH/g, from 20 to 55 mg KOH/g, or from 35 to 50 mg KOH/g.

### EXAMPLES

Adhesive Compositions were prepared having ingredients as summarized in Table 1.

TABLE 1
Adhesive Compositions.

| | Compar- | | | Compar- | |
|---|---|---|---|---|---|
| | ative | | | ative | |
| Ingredients | Ex. 1 | Ex. 2 | Ex. 3 | Ex. 4 | Ex. 5 |
| Solvent-borne Acrylic | 62 | 72 | 72 | | |
| Resin Locktite Duro-Tak | | | | | |
| 230A [1] | | | | | |
| Solvent-borne Acrylic | | | | 62 | 72 |
| Resin Aroset 1930-Z- | | | | | |
| 47 [2] | | | | | |
| Carbon Black [3] | 27 | 27 | 27 | 27 | 23 |
| BykJet 9133 Polymeric | 11 | | | 11 | |
| Dispersant [4] | | | | | |
| Disperbyk 2013 Polymeric | | 6 | | | |
| Dispersant [5] | | | | | |
| Disperbyk 2155TF | | | 6 | | 6 |
| Polymeric | | | | | |
| Dispersant [6] | | | | | |
| Rheology Modifier | 0 | 1 | 1 | 0 | 1.5 |
| E100 [7] | | | | | |
| Peel Force (N/inch) | 1.8 | 7.9 | 7.4 | 2.1 | 6.8 |
| Defects after 5 days | | | | Numerous | |
| Defects after 10 days | Numerous | | | Numerous | |

[1] Solvent-borne acrylic composition supplied by Henkel.
[2] Solvent-borne acrylic composition supplied by Bostic.
[3] Carbon Black Nipex 150, supplied by Orian Engineered Carbons.
[4] Polymeric dispersant with molecular structure containing alkylammonium salt of high molecular weight polymer, supplied by Byk Chemie.
[5] Polymeric dispersant with molecular structure containing SMA backbone and side chains having quaternary ammonium groups, supplied by Byk Chemie.
[6] Polymeric dispersant with molecular structure containing polyethylenimine backbone and polyglycol polyester, supplied by Byk Chemie.
[7] Ethocel 100 rheology modifier.

The ingredients of each of the examples (Comparative Examples 1 and 4, and Examples 2, 3, and 5) were mixed to prepare adhesive compositions. The adhesive compositions were used to prepare adhesive films adhering together a sealing layer of a microcell electro-optic device and a second electrode layer comprising a plurality of pixel electrodes. The adhesive layers were prepared thermally by solvent evaporation.

After curing of the adhesive composition, the prepared devices were evaluated for the peel forced required to cause delamination using Instron® Tester and peel angle of 90°. The peel forces arm provided in Table 1. Table 1 shows that the peel force required for the Comparative Examples were significantly lower than that of the inventive Examples.

After curing of the adhesive composition, the prepared devices were aged at 85° C. and relative humidity of 85%. Each adhesive layer was observed for defects at various times. FIG. 9 shows the defects over time of the Comparative Example 1 and inventive Examples 2 and 3. FIG. 10 shows the defects over time of the Comparative Example 4 and inventive Example 5. FIGS. 9 and 10 show that the defects of the comparative examples were significantly more from the defects of the corresponding inventive examples. Micrographs of the adhesive layers of all the examples were collected after aging of 5 days and after 10 days.

The images confirm the improvements that were achieved by the use of the inventive polymeric dispersants in the adhesive layers. Likely, the inventive polymeric dispersants provide both (i) stabilization towards aggregation of the conductive filler and (b) adhesion promotion.

Another set of adhesive compositions were prepared as summarized in Table 2. The inventive compositions comprised a crosslinker. That is, the acrylate resin in the adhesive layer was crosslinked.

The ingredients of each of the examples (Comparative Example 6 and Examples 7, 8, 9, and 10) were mixed to prepare adhesive compositions. The adhesive compositions were used to prepare adhesive films adhering together a sealing layer of a microcell electro-optic device and a second electrode layer comprising a plurality of pixel electrodes. The adhesive layers were prepared thermally by solvent evaporation.

TABLE 2
Adhesive Compositions Comprising a Crosslinker.

| | Comparative | | |
|---|---|---|---|
| Ingredients | Ex. 6 | Ex. 7 | Ex. 8 |
| Solvent-borne Acrylic Resin Locktite Duro- | 71.3 | 70.8 | 70.8 |
| Tak 154AHS [8] | | | |
| Carbon Black [3] | 23.0 | 23.0 | 23.0 |
| Disperbyk 2013 Polymeric Dispersant [5] | 5.7 | 5.7 | 5.7 |
| Crosslinker titanium acetylacetonate | | 0.5 | |
| Crosslinker aluminum acetylacetonate | | | 0.5 |
| Crosslinker highly methylated melamine [9] | | | |
| Crosslinker partially methylated melamine [10] | | | |
| Volume Resistivity at 0° C. (Ohm*cm) | 2.43 × 10¹¹ | 2.47 × 10¹¹ | 2.24 × 10¹¹ |
| Volume Resistivity at 25° C. (Ohm*cm) | 7.37 × 10¹⁰ | 9.37 × 10¹⁰ | 6.44 × 10¹⁰ |
| Volume Resistivity at 50° C. (Ohm*cm) | 5.29 × 10⁹ | 1.72 × 10¹⁰ | 1.23 × 10¹⁰ |

| Ingredients | Ex. 9 | Ex. 10 |
|---|---|---|
| Solvent-borne Acrylic Resin Locktite Duro- | 66.3 | 66.3 |
| Tak 154AHS [8] | | |
| Carbon Black [3] | 23.0 | 23.0 |
| Disperbyk 2013 Polymeric Dispersant [5] | 5.7 | 5.7 |
| Crosslinker titanium acetylacetonate | | |
| Crosslinker aluminum acetylacetonate | | |
| Crosslinker highly methylated melamine [9] | 5.0 | |
| Crosslinker partially methylated melamine [10] | | 5.0 |
| Volume Resistivity at 0° C. (Ohm*cm) | 2.58 × 10¹¹ | 2.44 × 10¹¹ |
| Volume Resistivity at 25° C. (Ohm*cm) | 1.46 × 10¹¹ | 1.07 × 10¹¹ |
| Volume Resistivity at 50° C. (Ohm*cm) | 1.93 × 10¹⁰ | 1.54 × 10¹⁰ |

[3] Carbon Black Nipex 150, supplied by Orian Engineered Carbons.
[5] Polymeric dispersant with molecular structure containing SMA backbone and side chains having quaternary ammonium groups, supplied by Byk Chemie.
[8] Solvent-borne acrylic composition supplied by Henkel; the acrylic resin of the composition has the same structure as the acrylic resin of Locktite Duro-Tak 230A composition.
[9] Cymel ®303, supplied by Allnex.
[10] Cymel ®370, supplied by Allnex.

The ingredients of each of the examples (Comparative Example 6 and Examples 7, 8, 9, and 10) were mixed to prepare adhesive compositions. The adhesive compositions were used to prepare adhesive films adhering together a sealing layer of a microcell electro-optic device and a second electrode layer comprising a plurality of pixel electrodes. The adhesive layers were prepared thermally by solvent evaporation.

The volume resistivity of the adhesive layers were determined using Model 8009 Resistivity Fixture and Model 6571 Electrometer supplied by Keithley. This equipment allows the user to determine the volume resistivity of a free-standing film by applying an alternating voltage to the substrate and measuring the output electric current. From the voltage and the current, the electrical resistance of the sample was calculated. The method includes coating of an adhesive composition, curing of the film, and conditioning of the film for 4 days at 25° C. The thickness of the conditioned adhesive film was measured, and the film was place on the substrate of the electrometer at the desired temperature (0° C. 25° C., and 50° C.) and at 55% RH. This equipment allows the user to determine the volume resistivity of a free-standing film by applying an alternating voltage to the substrate and measuring the output electric current. From the voltage and the current, the electrical resistance of the sample was calculated.

The data of Table 3 showed that the volume resistivity of all adhesive layers (comparative Example 6 and Inventive Examples 7-10). However, the volume resistivity of Comparative Example 6 at 50° C. is significantly lower (5.29×10⁰⁹ Ohm·cm) than the resistivities of all Inventive Examples 7, 8, 9, and 10 (1.72×10¹⁰ Ohm·cm, 1.23×10¹⁰ Ohm·cm, 1.93×10¹⁰ Ohm·cm, and 1.54×10¹⁰ Ohm·cm, respectively). This means that the inventive electro-optic devices having adhesive layers comprising a crosslinked acrylic resin show better electro-optic performance (less blooming).

The claimed invention is:

1. An electro-optic device comprising in order:
a first light transmissive electrode layer; an electro-optic material layer; an adhesive layer; and a second electrode layer, the second electrode comprising a plurality of pixel electrodes;
wherein the electro-optic material layer comprises a microcell layer or a microcapsule layer;
wherein the microcell layer comprises a plurality of microcells and a sealing layer, each microcell of the plurality of microcells comprising a microcell bottom, partition walls, and an opening, the sealing layer spanning the opening of each microcell, each microcell of the plurality of microcells containing an electrophoretic medium, the electrophoretic medium comprising charged pigment particles in a non-polar liquid, the adhesive layer being disposed between the sealing layer of the microcell layer and the second electrode layer;
wherein the microcapsule layer comprises a plurality of microcapsules and a binder, each microcapsule of the plurality of microcapsules containing an electrophoretic medium, the electrophoretic medium comprising charged pigment particles in a non-polar liquid, the adhesive layer being disposed between the microcapsule layer and the second electrode layer;
wherein the adhesive layer comprises:
an acrylic resin at a content of from 30 weight percent to 90 weight percent by weight of the adhesive layer excluding volatile solvents;
a conductive filler at a content of from 5 weight percent to 35 weight percent of the conductive filler by weight of the adhesive layer excluding volatile solvents; and
a polymeric dispersant at a content of from 1 weight percent to 20 weight percent by weight of the adhesive layer excluding volatile solvents, the polymeric dispersant having a molecular structure, the molecular structure containing a polymer or copolymer backbone and two or more side chains, the polymer backbone being a styrene-maleic anhydride copolymer or a polyalkylenimine polymer, and at least one of the two or more side chains containing a functional group selected from the group consisting of aromatic, ester, amide, amino, quaternary ammonium, hydroxy, carboxylic acid, and polyalkylene oxide.

2. The electro-optic device of claim 1, wherein the acrylic resin is crosslinked.

3. The electro-optic device of claim 2, wherein the acrylic resin is crosslinked with a metal acetylacetonate crosslinker.

4. The electro-optic device of claim 3, wherein the metal acetylacetonate crosslinker is titanium acetylacetonate or aluminum acetylacetonate.

5. The electro-optic device of claim 2, wherein the acrylic resin is crosslinked with a melamine derivative.

6. The electro-optic device of claim 5, wherein melamine derivative contains a functional group selected from the group consisting of methoxymethyl functional group and methylol functional group.

7. The electro-optic device of claim 1, wherein the conductive filler is carbon black.

8. The electro-optic device of claim 1, wherein the number average molecular weight of the polymeric dispersant is from 800 to 4000 g/mol.

9. The electro-optic device of claim 1, wherein the molecular structure of the polymeric dispersant contains a styrene-maleic anhydride copolymer backbone, and at least one of the two or more side chains contains an amino functional group or a quaternary ammonium functional group.

10. The electro-optic device of claim 9, wherein at least one of the two or more side chains contains a quaternary ammonium group and a polyester side chain.

11. The electro-optic device of claim 9, wherein at least one of the two or more side chains contains a polyethylene oxide, a polypropylene oxide, or both a polyethylene oxide and a polypropylene oxide.

12. The electro-optic device of claim 9, wherein at least one of the two side chains contains an aromatic ring.

13. The electro-optic device of claim 9, wherein the polymeric dispersant has an amine value of from 12 to 50 mg KOH/g.

14. The electro-optic device of claim 1, wherein the molecular structure of the polymeric dispersant contains a polyalkylenimine polymer backbone, and at least one of the two or more side chains contains an amino or a quaternary ammonium functional group.

15. The electro-optic device of claim 14, wherein the polyalkylenimine polymer backbone has a polyethylenimine polymer backbone.

16. The electro-optic device of claim 15, wherein at least one of the two or more side chains contains an ester functional group, and a polyethylene oxide functional group.

17. The electro-optic device of claim 15, wherein at least one of the two or more side chains contains a polyethylene oxide, a polypropylene oxide, or both a polyethylene oxide and a polypropylene oxide.

18. The electro-optic device of claim 14, wherein at least one of the two side chains contain an aromatic ring.

19. The electro-optic device of claim 14, wherein polymeric dispersant has an amine value of from 15 to 60 mg KOH/g.

20. The electro-optic device of claim 1, wherein the adhesive layer is formed by curing of an adhesive composition, the adhesive composition comprising the acrylic resin, the conductive filler, the polymeric dispersant, and a volatile solvent, the curing being achieved by solvent evaporation.
